(19) United States
(12) Patent Application Publication
(10) Pub. No.: US 2015/0183319 A1
(43) Pub. Date: Jul. 2, 2015

(54) ELECTROMOTIVE FOUR-WHEEL MOTORCYCLE

(71) Applicant: Bongseok Oh, Gyeongsangbuk-do (KR)

(72) Inventor: Bongseok Oh, Gyeongsangbuk-do (KR)

(21) Appl. No.: 13/978,460

(22) PCT Filed: Aug. 25, 2011
(86) PCT No.: PCT/KR11/06263

§ 371 Date: Sep. 11, 2013

(30) Foreign Application Priority Data
Jan. 5, 2011 (KR) 10-2011-0000759

(51) Int. Cl. B60K 17/34; B62K 5/08; B62K 5/01

(52) U.S. Cl. CPC B60K 17/34; B62K 5/01; B62K 5/08

(57) ABSTRACT

The present invention relates to a four-wheel all-terrain motorcycle. The four-wheel motorcycle includes: a body coupled to a frame; an operating part disposed on a front side portion of the body, the operating part including handles on both sides thereof to steer wheels and control transmission of power; a sheet part coupled to a side of an upper portion of the body; a front wheel shaft disposed on a front of the body; front wheels including first and second wheels respectively coupled to both ends of the front wheel shaft; a first rear-wheel connecting body coupled to one side of the rear of the body; a second rear-wheel connecting body coupled to the other side of the rear of the body; rear wheels including a third wheel coupled to the first rear-wheel connecting body and a fourth wheel coupled to the second rear-wheel connecting body; a first motor coupled to a side of the third wheel to provide torqueto the third wheel; a second motor coupled to a side of the fourth wheel to provide torqueto the fourth wheel; and a controller electrically connected to the first and second motors to simultaneously or individually control the rotation speed of the first and second motors. According to the present invention, the controller may simultaneously or individually control the rotation speed of the first and second motors to allow stable driving on roads having rough road surfaces. Also, a curved path driving detection unit detects a rotation direction and angle, and the controller individually controls the rotation speed of the first and second motors according to the detected values so that an inner wheel has a rotation speed less than that of an outer wheel. Thus, when a vehicle is driven along a curved path, stability may be improved. Also, when an emergency stop is required, it may be easily executed by a user who is accustomed to driving an automobile because it is performed by applying a foot brake system generally found in automobiles. In addition, a foot brake and a hand brake may be operated at the same time to improve braking power.

### TECHNICAL FIELD

According to the present invention, the controller may simultaneously or individually control the rotation speed of the first and second motors to allow stable driving on roads having rough road surfaces. Also, a curved path driving detection unit detects a rotation direction and angle, and the controller individually controls the rotation speed of the first and second motors according to the detected values so that an inner wheel has a rotation speed less than that of an outer wheel. Thus, when a vehicle is driven along a curved path, stability may be improved.

### BACKGROUND DESCRIPTION

A rise in the per capita enjoying leisure activities has created demand for electromotive four-wheel drive motorcycles and many electromotive four-wheel drive motorcycles are coming on the market.

The drive method for most four-wheelers are two-wheel drive (2WD) and four-wheel drive (4WD), and two-wheel drive comes in either front-wheel drive or rear-wheel drive.

Front-wheel drive four-wheelers are used most often in rocky areas, and rear-wheel drive and four-wheel drive is most used according to geographical features. Four-wheel drive is useful for getting through rough terrain, but there is the issue of being costly due to the manufacturing costs involved, so there is a trend among riders to select the rear-wheel drive type.

FIG. 1 is a conceptual diagram of a traditional four-wheeler with rear-wheel drive.

By referring to the figure you will notice the traditional rear-wheel drive set-up with the body (100), and the front axle (200) that connects to the upper part of the body, the, the front wheels (210) that are connected in a fixed position to the front axle (200) on both sides, and connected to the front wheels (210) are the operation unit (300) that controls the steering angle of the front wheels (210), and the rear axle (400) that connects to the lower part of the body (100), the rear wheels (410) that are connected in a fixed position to the rear axle (400) on both sides, and includes the power transmission part (500) that transfers torque to the rear axle (400).

The traditional rear-wheel drive set up refers to the control of the operation unit (300) to the rotational angle of the front wheels (210), the transmission part (500) rotates the rear axle (400) driving the rear wheels (410) on both sides. When this happens the front wheels (210) require no further driving force and are coupled in rotation relying on drive from the rear wheels (410).

Such a traditional rear-wheel drive method provides rotational forces for the rear Wheels (410) at the same time so in case each tire encounters a different type of terrain one rear-wheel (410a) encounters terrain that is slippery causing it to spin, and the other rear-wheel (410b) encountering normal terrain cannot advance causing it to spin and the friction with the ground results in tire wear occurring.

In particular when driven on a curved path the rear wheels on the left and right (410) provide the torque at the same time causing strain to the outer side with the risk of causing the vehicle to overturn throwing the driver into a wall or other obstruction.

And on a traditional four-wheeler there are grips that protrude on both sides of the operation unit (300) for control, and hand brakes (700) on either sides of the grips to provide braking. Under normal conditions automobile drivers normally accustomed to operating a foot brake may be unaccustomed to using a hand brake (700) causing severe problems to occur in situations when sudden braking is required.

Accordingly, to overcome such illogical aspects of traditional rear-wheel drive four-wheelers the rear wheels (410) on the left and right each provide different rotational force making it convenient for rough surfaces, and now boosts demand for four-wheel drive four-wheelers that have convenient braking features that automobile drivers are familiar with.

### DETAILED DESCRIPTION OF THE INVENTION

### Technical Project

The present invention was invented to solve the problems mentioned above, with the purpose of the present invention being to offer a four-wheel all terrain motorcycle that is convenient to ride on rough surfaces due to the rear wheels that rotate independently.

Another purpose for this invention is that when cornering the inside wheel will have a slower rotational speed than the outside wheel giving a more stable ride.

Another purpose of this invention is to offer a four-wheel all terrain motorcycle that has a foot brake which provides users a convenient braking system that can be controlled as with a car.

### Methods for Solving Problems

To achieve the above mentioned purposes according to the present invention relates to a four-wheel all-terrain motorcycle. The four-wheel motorcycle includes: a body coupled to a frame; an operating part disposed on a front side portion of the body, the operating part including handles on both sides thereof to steer wheels and control transmission of power; a sheet part coupled to a side of an upper portion of the body; a front wheel shaft disposed on a front of the body; front wheels including first and second wheels respectively coupled to both ends of the front wheel shaft; a first rear-wheel connecting body coupled to one side of the rear of the body; a second rear-wheel connecting body coupled to the other side of the rear of the body; rear wheels including a third wheel coupled to the first rear-wheel connecting body and a fourth wheel coupled to the second rear-wheel connecting body; a first motor coupled to a side of the third wheel to provide rotational force to the third wheel; a second motor coupled to a side of the fourth wheel to provide rotational force to the fourth wheel; and a controller electrically connected to the first and second motors to simultaneously or individually control the rotation speed of the first and second motors.

Also, when the above body detects curved path driving, including the curved path driving detection unit which displays the correlating sensing signal, and the above controller based on that sensing signal analyzes the direction of the curve and slows the rotational force of the inner wheel controlling the speed of the first motor and second motor.

Here the curved path driving detection unit includes a tilt sensor, acceleration sensor, a steering angle sensor which are all features of this four-wheel all terrain motorcycle.

Also the above brakes reducing the speed of front and rear wheels were included, the above brakes are installed in both grips controlled speed reduction in the rear wheels by hand brake, and foot brakes are installed providing in help controlling speed in the front and rear wheels at the same time.

Here the above foot brake is connected with a pneumatic cylinder, and the above pneumatic cylinder is connected to the first wheel, second wheel, third wheel and fourth wheel brake pads so when the foot brake is applied or released the brakes can be engaged and disengaged from the first wheel, second wheel, third wheel and fourth wheel.

### Effects of the Invention

According to the present invention, the controller may simultaneously or individually control the rotation speed of the first and second motors to allow stable driving on roads having rough road surfaces.

Also, a curved path driving detection unit detects a rotation direction and angle, and the controller individually controls the rotation speed of the first and second motors according to the detected values so that an inner wheel has a rotation speed less than that of an outer wheel.

Also, when an emergency stop is required, it may be easily executed by a user who is accustomed to driving an automobile because it is performed by applying a foot brake system generally found in automobiles. In addition, a foot brake and a hand brake may be operated at the same time to improve braking power.

### BRIEF DESCRIPTION OF FIGURES

FIG. 1 is a conceptual diagram of a traditional four-wheeler with rear-wheel drive.

FIG. 2 is a drawing of the four-wheel all terrain motorcycle.

FIG. 3 is a conceptual diagram that shows the overall structure of the four-wheel all terrain motorcycle.

FIG. 4 is a drawing of the four-wheel all terrain motorcycle when the vehicle is turning in a curve.

FIG. 5 is a distribution diagram about the speed control of the rear wheels when riding through a curve.

FIG. 6 is a comparative plan of the inner wheel and outer wheel rotation speed when riding at an angle.

FIG. 7 is a distribution diagram that shows the relationship between the operation of the brakes according to the present invention.

FIG. 8 is a drawing that shows by diagram the relationship between the combination of the brakes according to the present invention.

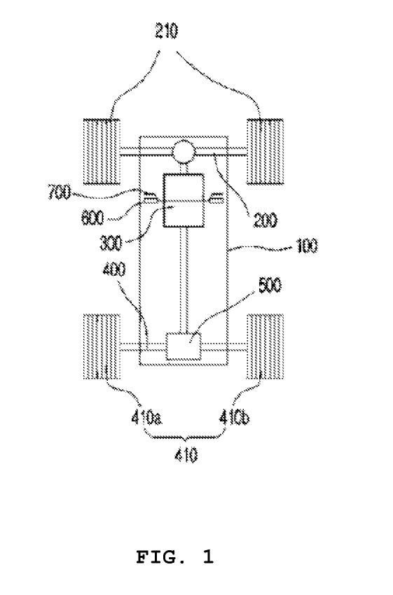

### Form for Implementing Invention

Refer to the attached figure below for a detailed description of the desired examples of implementation.

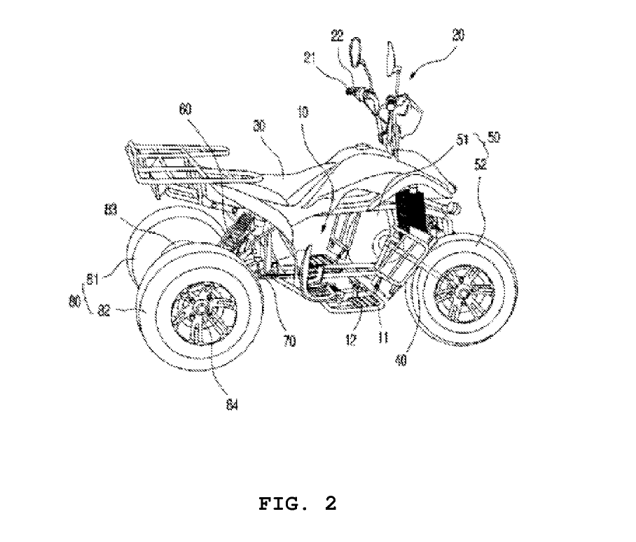

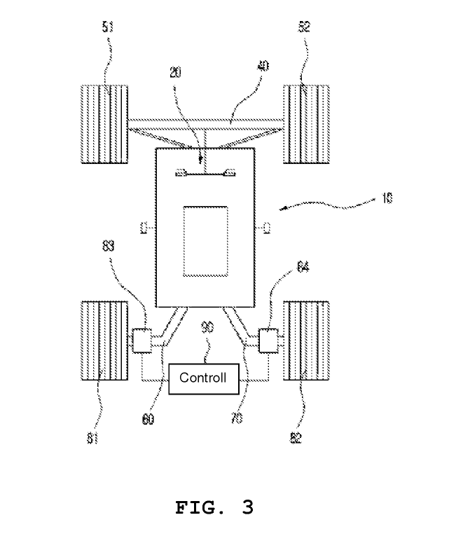

FIG. 2 is a drawing of the four-wheel all terrain motorcycle according to the present invention, and FIG. 3 is a conceptual drawing of the of the four-wheel all terrain motorcycle according to the present invention.

By referring to the figure, the four-wheel all terrain motorcycle according to the present invention includes the body (10), and connected to the front side of the body (10) is the installed operation unit (20), and connecting to the upper side of the body (10) is the seat part made of elastic material (30), the front axle (40) installed on the front side of the body (10), the front wheels (50) connected to either end of the front axle (40), the first rear-wheel connecting body (60) to the rear of either side of the body (10) and second rear-wheel connecting body (70), the third wheel (81) and fourth wheel (82) connecting to the rear-wheel connecting body, the third wheel (81) and fourth wheel (82) connecting to the first motor (83) and the second motor (82) and the controller (90).

The body (10) supports each part that is installed onto the body connecting it with the metal frame. A foot rest (11) is installed on either side of the lower body (10) for the feet, and there is a foot brake (12) installed on one of the foot rests (11).

The operation unit (20) is installed on the front upper side of the body (10) connecting with the grips (21) on both sides, and handbrakes (22) are installed on both grips (21). The operation unit (20) controls the wheels direction and power transmission. Here the steering of the front wheels (50) that are have an axle bond with the grips (21) changes with the left and right movement of the grips (21). And the power transmission works by the rider controlling the grips (21) an electric signal is transferred to the first motor (83) and second motor (84) according to how far back the grip is twisted powering the rear wheels (80).

The front wheels (50) include the first wheel (51) and second wheel (52) that are connected to either sides of the front axle (40). The first wheel (51) and second wheel (52) do not provide much rotational force, the drive comes from the rotation of the rear wheels (80).

One side of the first rear-wheel connecting body (60) is connected to the rear side of the body (10), the other side of the first rear-wheel connecting body (60) is connected to the third wheel (81). And the third wheel (81) is connected with the first motor (83) that provides the power transmission. Here it is desired if the first rear-wheel connecting body (60) be a metal frame.

One side of the second rear-wheel connecting body (70) is connected to the other rear side of the body (10), the other side of the second rear-wheel connecting body (70) is connected to the fourth wheel (84). And the fourth wheel (82) is connected with the second motor (84) that provides the power transmission. Here it is desired if the second rear-wheel connecting body (70) be a metal frame.

The controller (90) is connected electronically to the second motor (84) allowing the first motor (83) and second motor (84) to be controlled independently at the same time.

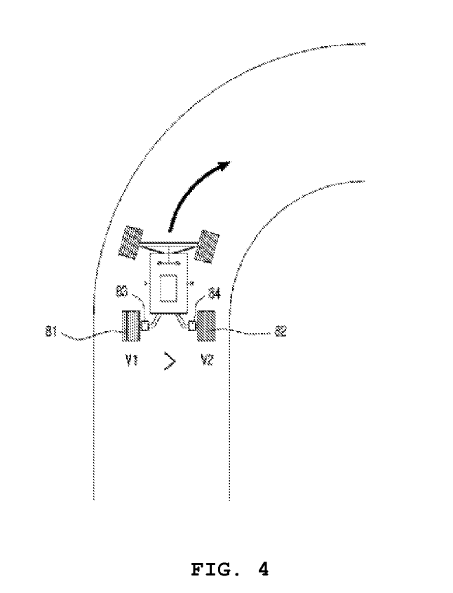

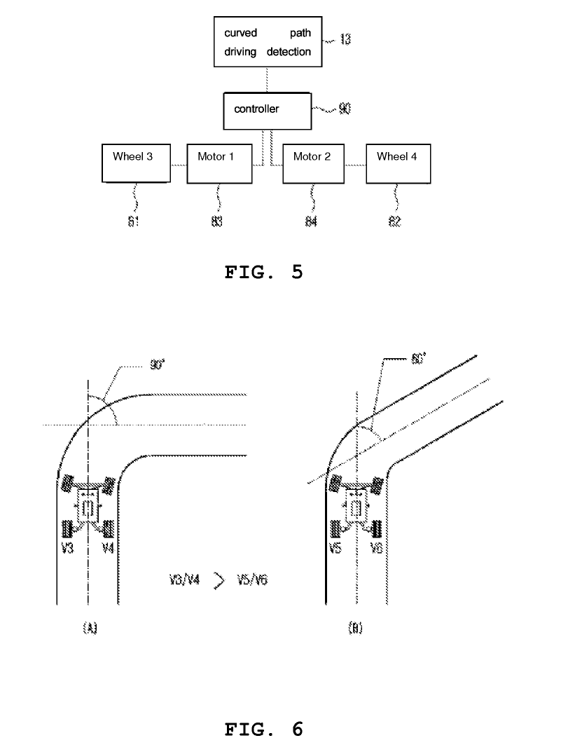

FIG. 4 is a drawing of the four-wheel all terrain motorcycle when the vehicle is turning in a curve, and FIG. 5 is a distribution diagram about the speed control of the rear wheels when riding through a curve.

By referring to the figure you will notice the curved path driving detection unit (13) is included in the body (10) of the four-wheel all terrain motorcycle.

The curved path driving detection unit (13) detects the curved path driving of the body (10) when the four-wheel all terrain motorcycle rides along a curved path. And the controller (90) analyzes the sensing signals from the curved path driving detection unit (13) recognizing the direction of the curved path driving and slows the rotational force of the inner wheel, independently controlling the speed of both the first motor (83) and second motor (84) that are mounted to the rear wheels (80).

Here it is desirable for the curved path driving detection unit (13) to have either a tilt sensor, acceleration sensor, or a steering angle sensor.

Below is a more detailed description of the relationship of the operation of the four-wheel all terrain motorcycle according to the present invention.

By referring to FIGS. 4 and 5 you can obtain an more detailed description of the independent operation of each motor during curved path driving.

During curved path driving the rider controls the grips (21) to rotate the front wheels (50) within limited direction. Here, the curved path driving detection unit (13) senses the body traversing a curved path (10) and transmits a sensing signal to the controller (90). And the controller (90) analyzes the rotation direction and reduces the rotation speed (V2) of the fourth wheel (82) so that it is less than the third wheel (81) which is the outer wheel (V1), and independently controls the first motor (83) and the second motor (84).

Here the sensing signal can sense the rotation angle or the rotation direction.

Also, according to changes in the rotation angle of the body (10) the rotational speed ratio of the third wheel (81) and fourth wheel (82) can be controlled in speeds that vary. Refer to FIG. 6 for a detailed description of how this works.

FIG. 6, as a comparative plan of the inner wheel and outer wheel rotation speed when riding at an angle, by referring to the figure when considering that the rotation angle on the riding path rotates at the same speed, one can see that when comparing the rotation angle of 90° on riding path (A) and the rotation angle of 60° on riding path (B) in the rotational angle of 90° on riding path (A) the rotational speed of the inside wheel (V4) and the rotational speed of the outside wheel (V3) has the rotational speed ration value (V3/V4) which is greater than the rotational angle of 60° on riding path (A) the rotational speed of the inside wheel (V6) and the rotational speed of the outside wheel (V5) has the rotational speed ration value (V5/V6).

When considering that they are rotating at the same speed the speed of the outside wheel (V3, V5) is the same and the speed of the inside wheel (V4, V6) has a different capacity for variation of velocity according to the rotational angle. Meaning, on riding path (A) with the rotational angle of 90° the inside wheel rotational speed (V4) has a slower rotational speed then the outside wheel rotational speed (V6) on rotational angle of 60°.

During curved path driving as above both wheels provide a different rotational speed reducing the phenomenon of centrifugal force that pushes the rider towards the outside allowing for more stable riding.

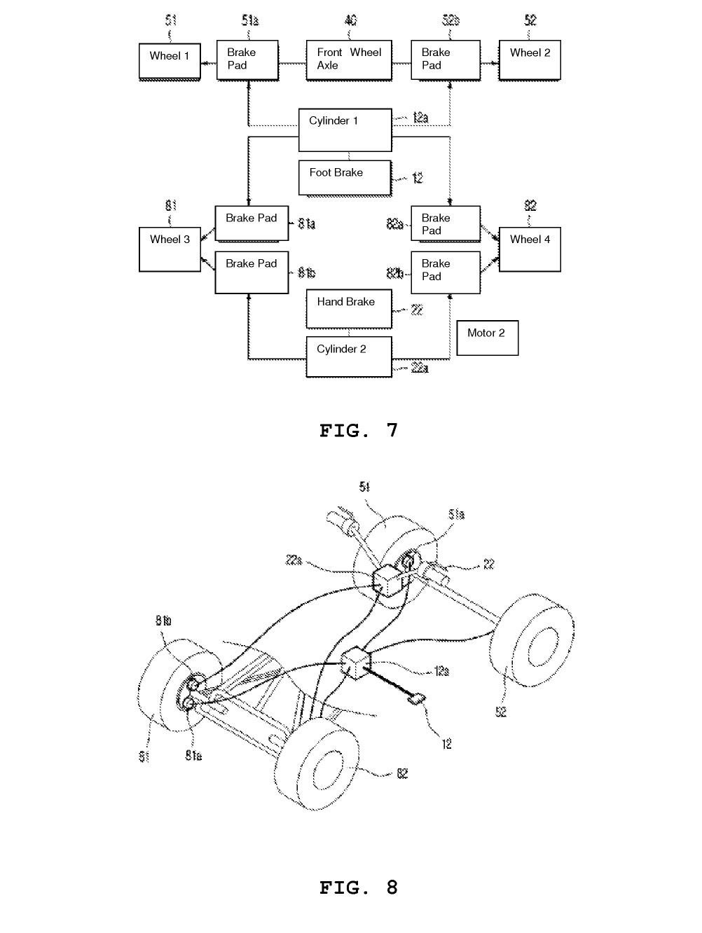

FIG. 7 is a distribution diagram that shows the relationship between the operation of the brakes according to the present invention, and FIG. 8 is a drawing that shows by diagram the relationship between the combination of the brakes according to the present.

By referring to the figure, you will see that according to the present invention of a four-wheel all terrain motorcycle brakes are included that reduce speed on the front wheels (50) and rear wheels (80).

The brakes consist of hand brakes (22) and a foot brake (12).

The hand brake (22) reduces speed on the rear wheels (80). Here the hand brake (22) is made up of a pneumatic cylinder connected to a second cylinder (22a) so when a reduction in speed is required the hand brakes are operated (22) transferring pneumatic pressure to the second cylinder (22a). And the second cylinder (22a) is connected to the third wheel (81) and fourth wheel (82) that both have brake pads (81b,82b) installed and the pneumatic pressure of the second cylinder (22a) is transferred to the brake pads (81b,82b). The pneumatic pressure transferred to the brake pads (81b,82b) causes the brakes to be applied or released, reducing wheel speed.

The foot brake (12) controls the speed of both the front wheels (50) and the rear wheels (80). Here when a reduction in speed is required the rider applies pressure on the foot brake (12) with the rider's foot and the foot brake (12) transfers pneumatic pressure to the first cylinder (12a) that consists of a pneumatic cylinder. And the first cylinder (12a) connects the first wheel (51), second wheel (52), third wheel (81) and fourth wheel (82) to the brake pads (51a,52a,81a,82a) and the pneumatic pressure of the first cylinder (12a) is transferred to each of the brake pads (51a,52a,81a,82a). The pneumatic pressure transferred to the brake pads (51a, 52a, 81a, 82a) engages or disengages the brake pads (51a,52a,81a,82a) controlling the speed.

Meaning the brake pads (81a,82a) connecting the first cylinder (12a) to the third wheel (81) and the fourth wheel (82) and the brake pads (81b,82b) connecting the second cylinder (12b) are both separately installed.

This allows the hand brakes (22) and foot brake (12) to be separately functional at the same time and allow for more effective braking when suddenly stopping.

And according to the present invention of a four-wheel all terrain motorcycle it includes a foot braking method that satisfies the conditions of regular automobile drivers allowing the rider accustomed to automobiles to easily control the vehicle using the foot brake (12).

Also, the hand brakes (22) are accustomed to bicycle riders making it easy to operate when braking.

Although above desired examples of implementation where described, the original invention and the range are not limited allowing for revisions or modifications to take place. Accordingly the scope of the attached patent application request includes such revisions or modifications to the original.

### DESCRIPTION OF THE MARK

10: body 11: foot rest

12: foot brake 12a: first cylinder

13: curved path driving detection unit 20: operation unit

21: grips 22: hand brakes

22a: second cylinder 30: seat part

40: front axle 50: front wheels

51: first wheel 52: second wheel

60: first rear-wheel connecting body 70: second rear-wheel connecting body

80: rear wheel 81: third wheel

82: fourth wheel 83: first motor

84: second motor 90: controller

What is claimed is:

1. a body coupled to a frame; an operating part disposed on a front side portion of the body, the operating part including handles on both sides thereof to steer wheels and control transmission of power; a sheet part coupled to a side of an upper portion of the body; a front wheel shaft disposed on a front of the body; front wheels including first and second wheels respectively coupled to both ends of the front wheel shaft; a first rear-wheel connecting body coupled to one side of the rear of the body; a second rear-wheel connecting body coupled to the other side of the rear of the body; rear wheels including a third wheel coupled to the first rear-wheel connecting body and a fourth wheel coupled to the second rear-wheel connecting body; a first motor coupled to a side of the third wheel to provide rotational force to the third wheel; a second motor coupled to a side of the fourth wheel to provide rotational force to the fourth wheel; and a controller electrically connected to the first and second motors to simultaneously or individually control the rotation speed of the first and second motors.

2. The above curve detection method includes a tilt sensor, acceleration sensor, a steering angle sensor which are all features of this four-wheel all terrain motorcycle.
